(19) United States
(12) Patent Application Publication
(10) Pub. No.: US 2008/0013805 A1
(43) Pub. Date: Jan. 17, 2008

(54) FINGER SENSING DEVICE USING INDEXING AND ASSOCIATED METHODS

(75) Inventors: Kuntal Sengupta, Belmont, MA (US); Michael Boshra, Indialantic, FL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: AuthenTec, Inc., Melbourne, FL (US)

(21) Appl. No.: 11/778,927

(22) Filed: Jul. 17, 2007

Related U.S. Application Data
(60) Provisional application No. 60/807,576, filed on Jul. 17, 2006.

(51) Int. Cl. G06K 9/00

(52) U.S. Cl. 382/124

(57) ABSTRACT

A finger sensing device includes a finger sensing area, and a processor cooperating therewith for reducing a number of possible match combinations between a sensed finger data set and each of a plurality of enrolled finger data sets. The processor may reduce the number of possible match combinations by generating a plurality of overlap hypotheses for each possible match combination, generating a co-occurrence matrix score based upon the plurality of overlap hypotheses for each possible match combination, and comparing the co-occurrence matrix scores to thereby reduce the number of possible match combinations. The processor may also perform a match operation for the sensed finger data set based upon the reduced number of possible match combinations. The sensed finger data set may include a sensed finger ridge flow data set, and each enrolled finger data set may include an enrolled finger ridge flow data set.

### RELATED APPLICATION

This application is based upon provisional patent application 60/807,576, filed Jul. 17, 2006, the entire contents of which are incorporated herein by reference.

### FIELD OF THE INVENTION

The present invention relates to the field of electronics, and, more particularly, to sensors, such as for finger sensing, and electronic devices using such sensors and associated methods.

### BACKGROUND OF THE INVENTION

Fingerprint sensing and matching is a reliable and widely used technique for personal identification or verification. In particular, a common approach to fingerprint identification involves scanning a sample fingerprint or an image thereof and storing the image and/or unique characteristics of the fingerprint image. The characteristics of a sample fingerprint may be compared to information for reference fingerprints already in a database to determine proper identification of a person, such as for verification purposes.

A particularly advantageous approach to fingerprint sensing is disclosed in U.S. Pat. No. 5,963,679 to Setlak et al., assigned to the assignee of the present invention, and the entire disclosure of which is incorporated herein by reference. The fingerprint sensor is an integrated circuit sensor that drives the user's finger with an electric field signal and senses the electric field with an array of electric field sensing pixels on the integrated circuit substrate. Such sensors are used to control access for many different types of electronic devices such as computers, cell phones, personal digital assistants (PDATs), and the like. In particular, fingerprint sensors are used because they may have a small footprint, are relatively easy for a user to use, and they provide reasonable authentication capabilities.

U.S. Published Patent Application No. 2005/0089203 also to Setlak, assigned to the assignee of the present invention, and the entire disclosure of which is incorporated herein by reference, discloses an integrated circuit biometric sensor that may sense multiple biometrics of the user, and that is also adapted to either a static placement sensor or a slide finger sensor. A slide finger sensor includes a smaller sensing surface over which the user's finger is slid. The images collected during the sliding process may be collected for matching, such as for authentication, or may be used for navigation, for example.

In a fingerprint identification system, it maybe desirable to match a fingerprint with several templates stored or enrolled in the database. This may be especially true in an access control system, where a limited number of people are granted access. The problem of matching the fingerprint with all of the stored templates or data sets may become prohibitively expensive, especially when the database size increases. Also, the false acceptance rate typically increases as the database size increases. Hence, it may be valuable to limit the number of enrolled image templates that is matched with the presented or sensed fingerprint data set.

One type of conventional indexing system uses gross features extracted from fingerprints and compares the sensed image and the templates using measures computed using these features. However, most of these gross level features are global in nature, implying that there is a high probability of error if partial fingerprints are available. For smaller fingerprint sensors, such as the model AES4000 offered by AuthenTec Inc. of Melbourne, Fla. and the assignee of the present invention, the difficulty of indexing using these global features becomes a challenging problem.

### SUMMARY OF THE INVENTION

In view of the foregoing background, it is therefore an object of the present invention to provide a finger sensing device and associated methods, that may efficiently perform indexing or reducing the number of possible match combinations.

This and other objects, features and advantages in accordance with the present invention are provided by a finger sensing device comprising a finger sensing area, and a processor cooperating therewith for reducing a number of possible match combinations between a sensed finger data set and each of a plurality of enrolled finger data sets. More particularly, the processor may reduce the number of possible match combinations by generating a plurality of overlap hypotheses for each possible match combination, generating a co-occurrence matrix score based upon the plurality of overlap hypotheses for each possible match combination, and comparing the co-occurrence matrix scores to thereby reduce the number of possible match combinations. The co-occurrence matrix scores may be compared to each other and a top percentage (e.g., top ten percent) selected, or each score can be compared to a threshold score for selection, for example. Of course, the processor may also perform a match operation for the sensed finger data set based upon the reduced number of possible match combinations. The sensed finger data set may comprise a sensed finger ridge flow data set, and each enrolled finger data set may comprise an enrolled finger ridge flow data set. The finger sensing device addresses the issues associated with smaller sensors, or partial fingerprints. Computing and comparing these features may use very simple arithmetic operations, and may be realized easily using low end processors and limited memory resources.

Reducing, as performed by the processor, may further comprise applying at least one filter to the plurality of overlap hypotheses prior to generating the co-occurrence matrix score. For example, the filter may comprise one or more of an overlap area filter, an overlap content filter, and a histogram based distance filter.

Since the sensed finger data set may comprise a sensed finger ridge flow data set, and the enrolled finger data sets may comprise enrolled finger ridge flow data sets, generating the co-occurrence matrix score may comprise reducing a number of matrix entries based upon ridge flow directions. For example, reducing the number of matrix entries may include reducing the number of matrix entries based upon ridge flow directions at a plurality of anchor points. The processor may also cooperate with the finger sensing area to generate the enrolled finger data sets. In addition, the enrolled finger data sets may comprise data relating to the plurality of anchor points.

The finger sensing area may comprise at least one of an electric field finger sensing area, a capacitive finger sensing area, an optical finger sensing area, and a thermal finger sensing area. Of course, the finger sensing device may be readily included in an electronic device, such as a cellphone, PDA, laptop, etc. that further includes a housing and a display carried by the housing.

A method aspect is for reducing a number of possible match combinations between a sensed finger data set and each of a plurality of enrolled finger data sets. The method may comprise generating a plurality of overlap hypotheses for each possible match combination, generating a co-occurrence matrix score based upon the plurality of overlap hypotheses for each possible match combination, and comparing the co-occurrence matrix scores to thereby reduce the number of possible match combinations.

### BRIEF DESCRIPTION OF THE DRAWINGS

FIG. 1 is schematic front elevational view of an electronic device in the form of a cellular telephone and including a finger sensing device in accordance with the present invention.

FIG. 2 is more detailed schematic diagram of a portion of the cellular telephone as shown in FIG. 1.

FIG. 3 is a flowchart of a method embodiment in accordance with the present invention as may be performed by the finger sensing device shown in FIGS. 1 and 2.

FIGS. 4A and 4B are sample images as in the prior art being different but having a common histogram.

FIGS. 5A-5C are schematic diagrams of a center point and its neighbors demonstrating pruning as may be used in the finger sensing device as shown in FIGS. 1 and 2.

FIGS. 6A and 6B are fingerprint images illustrating anchor points as may be used in the finger sensing device as shown in FIGS. 1 and 2.

FIG. 7 is a more detailed block diagram of the processor as used in the finger sensing device as shown in FIGS. 1 and 2.

FIG. 8 is a schematic diagram for computing good blocks in region D for the recursive approach as may be used in the finger sensing device as shown in FIGS. 1 and 2.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout to indicate similar elements.

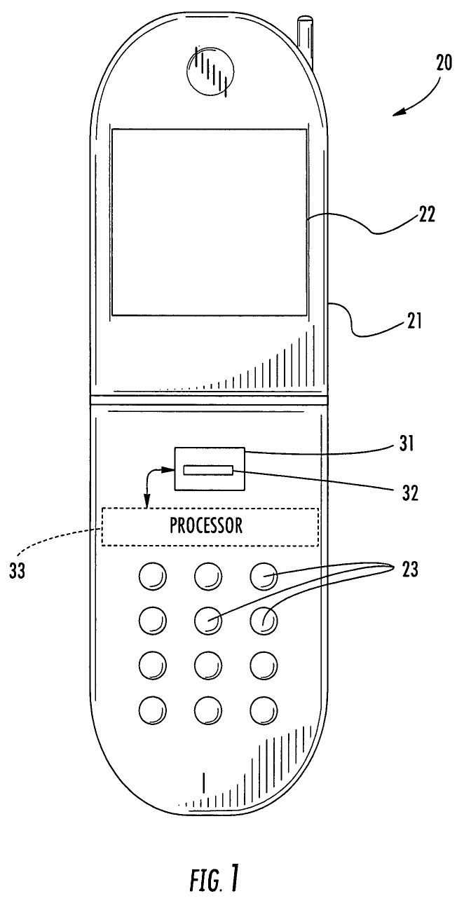

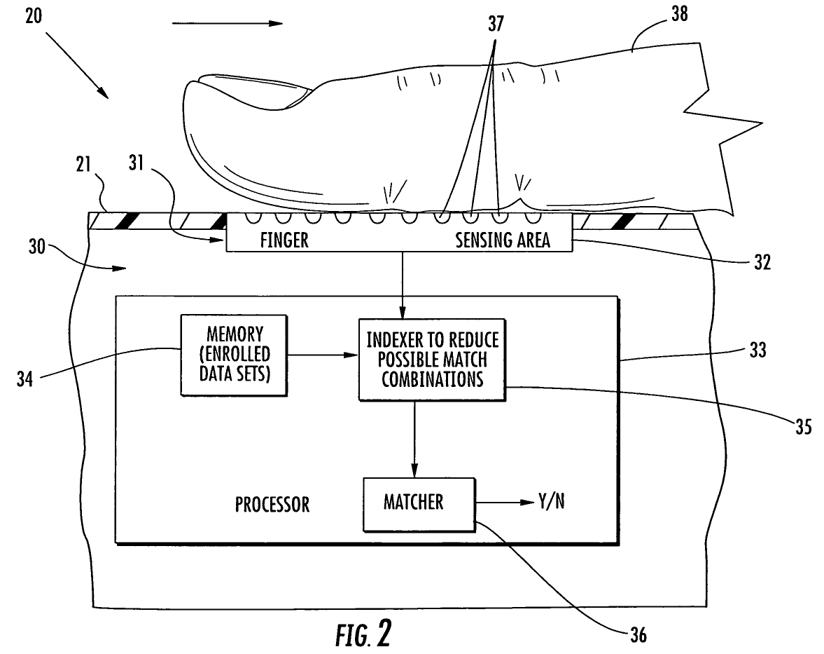

Referring initially to FIGS. 1 and 2 an electronic device in the form of a cellular telephone 20 includes the finger sensing device 30 according to the invention. The cellular telephone 20 is but one example of an electronic device that may benefit from the finger sensing device 30 as will be appreciated by those skilled in the art. The illustrated cellular telephone 20 includes a portable housing 21 that carries a display 22 and a keyboard 23. An integrated circuit finger sensor 31 is carried by the housing 21 and includes a finger sensing area 32 to receive a user's finger 38 (FIG. 2) moved in a sliding motion. The finger sensing area 32 may typically sense the image of ridges and valleys of a fingerprint, or may image other features of the user's finger, such as pores, or even subdermal features, as will be appreciated by those skilled in the art. Of course, other finger sensors could also be used. In other embodiments the finger sensing area 32 could be based upon static finger placement as will be appreciated by those skilled in the art.

The finger sensor 31 illustratively includes a processor 33 cooperating with the finger sensing area 32 for collecting image data therefrom. In some embodiments, the processor 33 may be provided by processing circuitry included on the integrated circuit substrate with the finger sensing area 32, and a host processor (not shown) as typically carried by the housing 21. Such a host processor for the cellular telephone 20 may typically perform the traditional processing for telephone functions, and may also have additional processing capability available for finger matching, finger navigation, etc. as will be appreciated by those skilled in the art. In other embodiments, the processor 33 may be implemented totally along with the finger sensing area 32 or in a separate integrated circuit as will also be appreciated by those skilled in the art.

The finger sensing area 32 illustratively includes an array of sensing pixels, such as electric field sensing pixels 37 formed on an integrated circuit substrate of the type as described in U.S. Pat. No. 5,963,679 to Setlak et al., assigned to the assignee of the present invention, and the entire contents of which are incorporated herein by reference. Of course, the finger sensing device 30 may be based upon other types of finger sensing as will be appreciated by those skilled in the art. For example, the finger sensing area 32 may comprise at least one of an electric field finger sensing area, a capacitive finger sensing area, an optical finger sensing area, and a thermal finger sensing area.

The processor 33 cooperates with the finger sensing area 32 for reducing a number of possible match combinations between a sensed finger data set and each of a plurality of enrolled finger data sets. The processor 33 illustratively includes a memory 34 for storing the enrolled finger data sets, coupled to the schematically illustrated indexer 35 that reduces the possible matching combinations. Accordingly, the processor 33 may reduce the number of possible match combinations by generating a plurality of overlap hypotheses for each possible match combination, generating a co-occurrence matrix score based upon the plurality of overlap hypotheses for each possible match combination, and comparing the co-occurrence matrix scores to a to thereby reduce the number of possible match combinations. The co-occurrence matrix scores may be compared to each other and a top percentage (e.g., top ten percent) selected, or each score can be compared to a threshold score for selection, for example.

The processor 33 also illustratively includes a matcher 36 to perform a match operation for the sensed finger data set based upon the reduced number of possible match combinations. The sensed finger data set may comprise a sensed finger ridge flow data set, and each enrolled finger data set comprises an enrolled finger ridge flow data set.

Reducing the possible match combinations, as performed by the processor 33, may further comprise applying at least one filter to the plurality of overlap hypotheses prior to generating the co-occurrence matrix score. For example, the at least one filter may comprise one or more of an overlap area filter, an overlap content filter, and a histogram based distance filter. These filters are discussed in greater detail below.

Since the sensed finger data set may comprise a sensed finger ridge flow data set, and the enrolled finger data sets may comprise enrolled finger ridge flow data sets, the processor 33 may generate the co-occurrence matrix score by first reducing a number of matrix entries based upon ridge flow directions. For example, reducing the number of matrix entries may include reducing the number of matrix entries based upon ridge flow directions at a plurality of anchor points. The processor may 33 also cooperate with the finger sensing area 32 to generate the enrolled finger data sets, and the enrolled finger data sets may comprise data relating to the plurality of anchor points.

The finger sensing device 30 may be readily included in an electronic device, such as the illustrated cellphone 20 (FIG. 1), a PDA, a laptop, etc. that further includes a housing and a display carried by the housing, for example. The finger sensing device 30 addresses the issues associated with smaller sensors, or partial fingerprints. Computing and comparing these features may use very simple arithmetic operations, and may be realized easily using low end processors and limited memory resources.

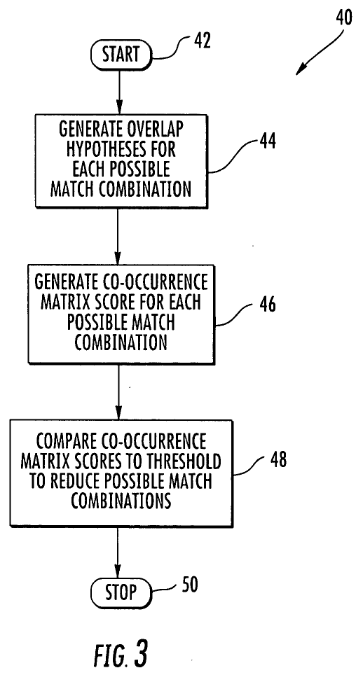

Referring now briefly and additionally to the flowchart 40 of FIG. 3, a method aspect is for reducing a number of possible match combinations between a sensed finger data set and each of a plurality of enrolled finger data sets. After the start (Block 42), the method includes at Block 44 generating a plurality of overlap hypotheses for each possible match combination. Thereafter at Block 46, a co-occurrence matrix score is generated based upon the plurality of overlap hypotheses for each possible match combination. At Block 48, the co-occurrence matrix scores are compared to a threshold score to thereby reduce the number of possible match combinations before stopping at Block 50. Again these steps are discussed in greater detail below.

There are a number of constraints that may be helpful to review. Since partial fingerprints are available for indexing, the features used should be able to capture local properties of the fingerprint. The features used should be simple, and should be computed rather inexpensively. Comparing two fingerprints based on these features should be computationally inexpensive. To allow for low end low memory processors, the approach should not inherently use memory expensive procedures, such as hash tables. The approach may make use of the ridge flow maps as much as possible, because a typical sensor system is available to give a clear picture of ridges, which may then also be used by the final matching algorithm.

There are also certain assumptions that may be helpful to consider. For example, a small set of “essential” data may be added to the template size. This will essentially be the information regarding the four anchor points, for example, (or points of significances) per enrolled data set or template. For faster computations (during indexing), an auxiliary set of “non-essential” data can be added to the template. Typically, for a fingerprint image of size N×N, this is an array of size (N/B)×(N/8) for every enroll template. Hence, the storage needs per node is (N/8)² bytes.

Those of skill in the art will recognize that co-occurrence matrices have been used widely in comparing textures, and for web based image indexing. They generalize the one dimensional histograms computed using the gray scale values in an image. This concept has been significantly extended for indexing using ridge flow maps computed from the fingerprint images as described in detail herein. A co-occurrence matrix of an image is a 3D array, indexed by C₁, C₂, and D, where C₁ and C₂ are the grayscale value axes, and D is the distance axis. In general, constructing a co-occurrence matrix A from an image IM of size N×N is constructed, for example, using the following algorithm:

```
For i=1 to n
For j=1 to n
    C₁ = IM(i,j);
    For D = 0 to Dₘₐₓ
        For ∀ (i₁,j₁) : Dist[(i,j) , (i₁,j₁)] = D
            C₂ = IM(i₁,j₁);
            A(C₁, C₂, D)= A(C₁, C₂,D)+1;
        End;
    End;
End;
```

In the above steps, the Dist( ) function computes the distance between two pixel locations. This could be Euclidean distance, the Manhattan distance, or any other convention one wishes to follow. Typically, Dₘₐₓ is 3 in most applications. Note that for D=0, then the diagonal (C₁=C₂) of the co-occurrence matrix is the same as histogram. Co-occurrence histograms have more descriptive power than histograms, because they capture the spatial relationship between two pixels as well.

To illustrate the point, consider the example in FIG. 4. The histogram of the two images 52, 53 are identical, while the co-occurrence matrices are not. Hence, a discriminant function based on co-occurrence matrices would perform a better job than those based on a histogram. In other words, the two images 52, 53 would have identical grayscale histograms, but different co-occurrence matrices.

There are several different types of discriminant functions that can be defined, given two co-occurrence matrices A1 and A2, corresponding to two images, respectively. One of the most frequently used measure is the intersection based distance, defined as

Dist(A1,A2)=1−pop(A1∩A2)/min(pop(A1),pop(A2)).

Here the pop( ) function indicates the population of the matrix, and is the sum of all the entries in the matrix. The (i,j,k) th element of the matrix A1∩A2, also known as the intersection co-occurrence matrix, is the minimum of A1(i,j,k) and A2(i,j,k). If the first image is a subset of the second image (or the vice versa), then A1∩A2=A1, and the distance value is 0.

In the present finger sensing device 30 which is driven by anchor point based overlap hypotheses generation and verification, below is tested the hypothesis that the first image is similar to the second image. The distance measure used is:

Dist(A1,A2)=1−pop(A1∩A2)/0.5(pop(A1)+pop(A2)).

The description now turns to the adaptation of co-occurrence matrices and their comparison for ridge flow maps. Indeed, the following substantial modifications were made to extend the concept of co-occurrence matrices for ridge flow map comparison. First, a modified distance function to deal with rotation is now described. Instead of computing co-occurrence matrices for fingerprint images, the processor computes the co-occurrence matrices of the ridge flow angles of the fingerprints. Comparing two ridge flow co-occurrence matrices using a distance measure is not as trivial as they can undergo significant rotation. Hence, a particular ridge flow value at a particular block in the enroll image may have a value of i₁, while the corresponding block in the match image can have a value of i₂=i₁+θ.

For this, a new co-occurrence matrix A2_{θ} is defined which is the co-occurrence matrix of ridge flow RF2_{θ} constructed from the ridge flow map RF2 by adding θ to each of its elements. The modified distance is computed for the θ value that generates the minimal distance value.

Dist(A1,A2)=min_{θ}Dist(A1,A2_{θ})

In the described embodiment, the ridge flow the search is conducted for θ in the range [−30°, 30°]. Also, in this embodiment, A2_{θ} is not computed explicitly. Instead, the following algorithm is adopted to compute pop(A1∩A2_{θ}).

```
pop = 0;
For i=1 to n
    For j=1 to n
        For D = 0 to Dₘₐₓ
            i₁ = i⊕ θ;
            j₁= j⊕ θ;
            pop = pop + min(A₁(i, j, D), A₂(i₁, j₁,D));
        End;
    End;
```

Note that the ridge flow angles for the purpose of co-occurrence matrix computation is quantized into 32 levels, implying that the range of θ (quantized) is [−6,6]. Also, note that ⊕ indicates a circular summation, since the ridge flow angle can vary between 0 and 180 or, between 0 to 31 in the quantized space (i.e., i₁⊕θ=(i₁+θ)mod 32.)

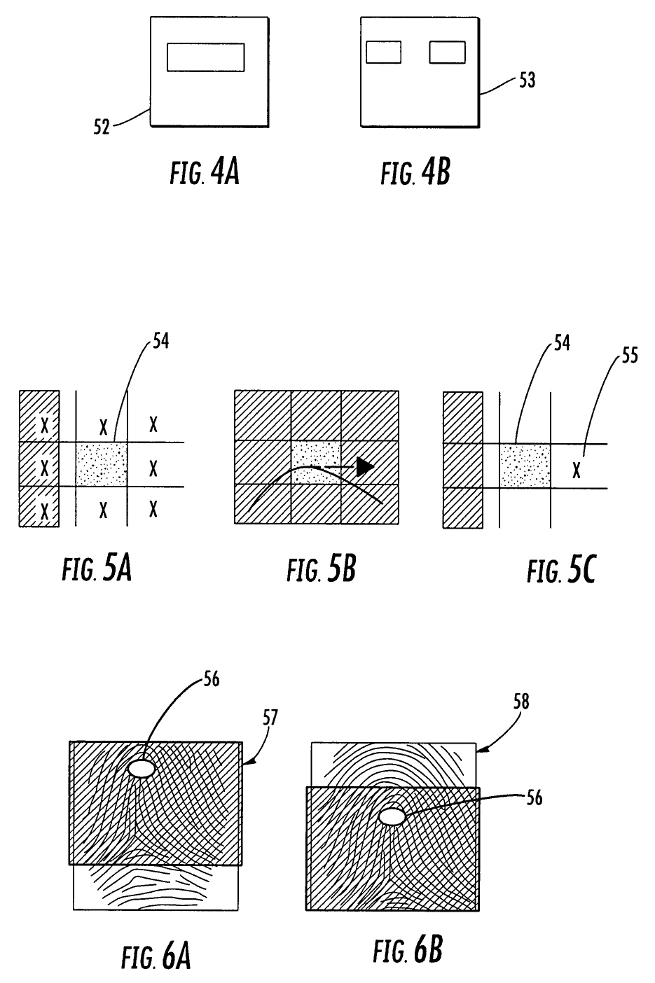

Another aspect relates to making the co-occurrence matrices less crowded to reduce false acceptance. Indexing involves comparing the match image with several enroll images, most of which do not belong to the same finger. It is well known in the literature that clutter in data can lead to high scores while comparing images that do not match, increasing the probability of false matches. This may be especially true for co-occurrence intersection based distance computation, because cluttered (or crowded) matrices generally tend to generate a crowded intersection co-occurrence matrix, leading to a low distance value. To reduce the “crowd” by keeping only meaningful, non-redundant information in the co-occurrence matrix, one more modification may be made for its construction. Instead of visiting all the blocks at a distance “d” away from the block located at (i,j), the ridge direction at the block (i,j) is followed to visit the block at a distance d, only in this direction. This choice is made because there are more variations in the ridge flow values along the ridge direction, as opposed to the direction perpendicular to the ridge. The process is illustrated in FIGS. 5A-5C. For d=1, entries need to be made for all the eight neighbors of the center block 54, leading to a total of eight entries (FIG. 5A). However, using the ridge direction (FIG. 5B) to the advantage, only the neighbor 55 shown in the FIG. 5C is used for making an entry in the array. As a result of this modification, the construction of the co-occurrence matrix becomes much faster, since approximately n²(Dₘₐₓ+1) entries need to be made now for a n×n ridge flow map.

A modification to deal with non-overlap is now described. To make the indexing work with small sensors, it is helpful to assume that the images Im1 and Im2 have significant non-overlap. Hence, the distance measure on their co-occurrence matrices will fail to provide an accurate discrimination between the two images. However, if one had a significant point of interest, formally called the anchor point (for example, a core point at location (xₑ, yₑ) in the enroll image, and (xₘ, yₘ) in the match image), one can generate the overlap hypothesis, and compare the co-occurrence matrices of the overlap region only.

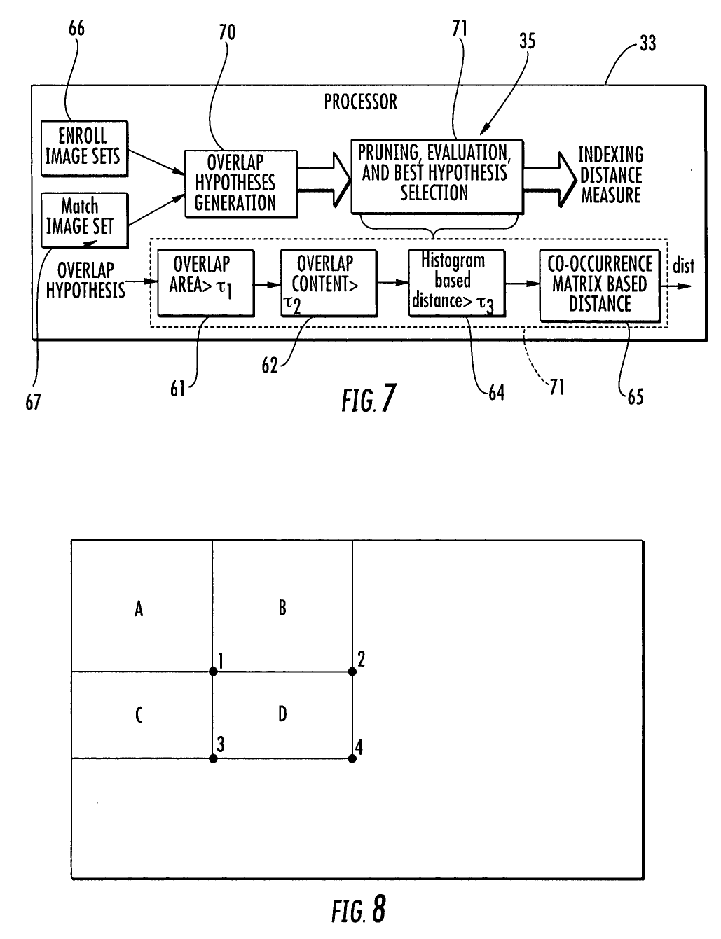

As illustrated in FIGS. 6A and 6B, once it is established that the interest point 56 in the left image 57 (FIG. 6A) matches the core 56 in the right image 58 (FIG. 6B), the overlap regions illustrated by cross-hatching may be used for ridge flow co-occurrence matrix construction. For example, there may be sixteen overlap hypotheses assuming the match and enroll images have four anchor points each. For each hypotheses, the distance measurement can be computed. Constructing co-occurrence matrices involves O(n²Dₘₐₓ) operations, where n×n is the size of the image, and is computationally expensive. Hence, it may be desirable to prune some of the overlap hypotheses, before computing the co-occurrence matrix based distance measure. Given two fingerprint images, the minimum distance value computed over all possible overlap hypotheses is preferably used as the indexing distance measure.

The hypotheses pruning is now further described with additional reference to FIG. 7. To compare an enroll image with a match image, as mentioned before, one can evaluate sixteen overlap hypotheses. Each evaluation uses an involved co-occurrence matrix computation and distance computation. Most of the overlap hypotheses can be pruned using the overlap area, and other similarity measures, that are comparatively simple to compute. The processor 33 is for generating the indexing distance (or score) measure. Note that most of the hypotheses are pruned using a set of filters, based on overlap, overlap content, and histogram based distance measure, as described below.

The first filter 61 corresponds to the minimum overlap area that is required before the next stage is invoked. The threshold τ₁ is set to n²/3, where n×n is the size of the ridge flow map. The second stage, or overlap content filter 62, corresponds to the overlap content, or the number of good blocks that are there in the enroll as well as the match ridge flow maps. The number of good blocks should exceed τ₂, which may be set to n²/3 for one implementation embodiment. The third stage, or histogram based distance filter 64, involves computing the histogram of the overlap areas and comparing them using a histogram intersection based distance d(H1,H2) (identical to co-occurrence matrix intersection based distance), where H1 and H2 are the enroll and the match (or sensed data set) histograms, respectively, computed on the overlap region. Since the co-occurrence matrix is a generalized version of the histogram, no further discussion is needed. The only point of note is that the rotation angle for the overlap hypothesis may be computed as

θₒₚₜ=arg min_{θ} Dist(H1,H2_{θ}).

If Dist(H1,H2) is less than τ₃ (=0.200 for an implementation), then this hypothesis is passed to the co-occurrence matrix based distance computation stage 65, along with θₒₚₜ. Note that this θₒₚₜ is re-used for co-occurrence matrix based distance computation. That is,

Dist(A1,A2)=Dist(A1,A2_{θopt})

Passing the rotation value from the histogram based distance computation stage saves a lot of computation time (by sacrificing very little in the indexing accuracy), especially since the co-occurrence matrix intersection based distance computation is usually more involved than the histogram intersection based distance computation.

The processor 33 operates upon the enroll image data sets 66 and the match or sensed image data set 67. The indexer 35 includes a block for performing overlap hypotheses generation 70 and the downstream pruning, evaluation and best hypothesis selection block 71 connected thereto. Note that the four stage pruning process is repeated for all (typically, sixteen) hypotheses. The hypothesis leading to the least distance value is chosen, and this distance value is recorded as the indexing distance between the enroll and the match image.

To further reduce the computation time in indexing, the following options have been introduced and may be used in various embodiments of the finger sensing device 30 as will be appreciated by those skilled in the art. First, local properties of anchor points may be used for pruning. For example, local properties of the ridge flow map, around the anchor points, can be used to further prune the number of overlap hypotheses. In one embodiment, one can use the Harris Cornerness Measure (an output of the Harris Corner Detector that is used for anchor point generation) at each of the anchor points. This comes at no extra cost, and its strength is an indication of the “rate of change” of the ridge flow angle values at that point. If a match anchor point's cornerness strength is less than half or more than double of the strength of a enroll image's anchor point, the pair is not evaluated any further. This particular filtering to a three fold increase in the speed of the indexing process, for example.

Second, integral images may be used for fast computation of the number of good blocks in a ridge flow map subregion. Since this counting routine is called most in the indexing process, it may lead to a substantial amount of indexing time, although it looks benign. If GB is the good block image, where GB(x,y)=1 for a good block at location (x,y), and 0 for a bad block, the integral good block image, IGB is defined as

IGB(x,y)=Σ_{(i≦x)}Σ_{(j≦y)}GB_{(x,y)}

A fast recursive solution to computing the integral good block images may be used, as shown in the following equations.

S(x,y)=S(x,y−1)+GB(x,y),

IGB(x,y)=IGB(x−1,y)+S(x,y).

As understood with additional reference to FIG. 8, the number of good blocks in a subregion D in the ridge flow map can be computed by four lookup operations in the integral good block image. Given a query subregion D bounded by the corners 1, 2, 4, and 3, with coordinate values (x₁,y₁), (x₂,y₁), (x₂,y₂) and (x₁, y₂), respectively. The number of good blocks inside the subregion can be computed using four lookups, by using the formula that the total number of good blocks=IGB(x₂,y₂)+IGB(x₁,y₁)−IGB(x₁, y₂)−IGB(x₂,y₁). The integral good block images for enroll nodes are stored in the templates, while it is computed during run time for the match image.

An efficient computation of intersection of co-occurrence matrices is further described as follows. The three dimensional co-occurrence matrices are usually very sparse. Typically, they have an occupancy of 10%. Thus, while computing the distance based on these matrices, it may make little sense to execute the three level deep loop (see the algorithm). Instead, for the two matrices to be compared, one can maintain a list of entry locations that have been filled up. For ease, lets assume the list is L1 for the matrix A1, and so on. While comparing A1 and A2, one visits every element in E1. The co-occurrence matrix location stored in this element is read out. The minimum value of the entries at this location in A1 and A2 is computed and added to the value of the variable pop (again, refer to the algorithm). Thus, instead of visiting 32*32*4 (≈4000) locations in the co-occurrence matrix, one can visit typically 400 locations only.

Avoiding redundant co-occurrence matrix computation by smart browsing is now further described. As the match ridge flow data is compared with a set of enroll image ridge flow data, it will become apparent to those skilled in the art that certain redundant computations are being made on the match ridge flow data. This is usually true for co-occurrence matrix and histogram computation in ridge flow subregions. Assuming that one is interested in verifying the hypothesis that the anchor point located at (xₑ, yₑ) in the enroll image (say EIm1) “aligns” with the match image anchor point (xₘ, yₘ). The parameters Δₓ=xₘ−xₑ and Δ_{y}=yₘ−yₑ uniquely define the subregion in the match image that would be used for the extraction of the co-occurrence matrix and histogram. For yet another enroll image (Eim2), if anchor point alignment leads to the same Δₓ and Δ_{y} values, then computing the same set of data yet again would be a waste of time. Thus, the concept of smart browsing is introduced, wherein one can browse through a list indexed by (Δₓ, Δ_{y}). This location of the list stores all the enroll images that are to be compared with the match image. The list is created on the first pass (over the template library). In the second pass, one can visit every location of the list, and for the corresponding (Δₓ, Δ_{y}) value, one computes the histogram and the co-occurrence matrix of the match ridge flow subregion. Next, all the enroll ridge flow subregions are compared with the match ridge flow subregion, without having to compute the relevant data for the match image over and over again. This may save a significant amount of computation. However, the assumption in this case is that the enroll image templates are available in the memory all together.

The discussion now turns to template information related to indexing. For indexing, one can store the anchor point information in the enroll image template. There are at most four anchor points, each of which requires 2 bytes to store the (x,y) location, and 2 bytes to store the Harris Cornerness Strength parameter. In total, the anchor point information requires 16 bytes per enroll image node. For faster computations in low end processors, it may be important to store the integral good block images as well. However, for 96×96 images, the ridge flow information is stored in a 24×24 array. The integral good block array therefore needs to be of size 24×24, and the maximum value (which is at location (24,24)) of the array can be 576. Thus, it uses 2 bytes per array location, and hence a total of 1152 bytes per enroll node. This can be reduced significantly by reducing the resolution to 12×12 for the integral good block image. For this choice, the total requirement for the array is 144 bytes. Thus, for every enroll image node, the template size requirement for indexing is 160 bytes. Since a template typically contains 5 nodes, the additional template size requirement for indexing is 800 bytes per finger.

Interfacing with the matcher is now further described. For templates (or fingers) with multiple enroll nodes, which is usually the case with composite templates, the co-occurrence matrix based distance computation process is repeated for every node, and the minimum indexing distance value is recorded as the indexing distance between the match image and the template. The node id, and the overlap information, as well as the rotation information can be passed to the matcher, and this can be used to its advantage. The process is repeated for all templates in the database. The template list is ordered on basis of this distance. The top 10% of the templates (i.e, those closest to the match image) are passed to the matching stage in the order generated by the indexing stage. Indeed, many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that other modifications and embodiments are intended to be included within the scope of the appended claims.

That which is claimed is:

1. A finger device comprising:
a finger sensing area; and
a processor cooperating with said finger sensing area for generating a sensed finger data set, and reducing a number of possible match combinations between the sensed finger data set and each of a plurality of enrolled finger data sets, the reducing comprising
generating a plurality of overlap hypotheses for each possible match combination,
generating a co-occurrence matrix score based upon the plurality of overlap hypotheses for each possible match combination, and
comparing the co-occurrence matrix scores to thereby reduce the number of possible match combinations.

2. The finger sensing device according to claim 1 wherein said processor also performs a match operation for the sensed finger data set based upon the reduced number of possible match combinations.

3. The finger sensing device according to claim 1 wherein the sensed finger data set comprises a sensed finger ridge flow data set; and wherein each enrolled finger data set comprises an enrolled finger ridge flow data set.

4. The finger sensing device according to claim 1 wherein reducing further comprises applying at least one filter to the plurality of overlap hypotheses prior to generating the co-occurrence matrix score.

5. The finger sensing device according to claim 4 wherein the at least one filter comprises an overlap area filter.

6. The finger sensing device according to claim 4 wherein the at least one filter comprises an overlap content filter.

7. The finger sensing device according to claim 4 wherein the at least one filter comprises a histogram based distance filter.

8. The finger sensing device according to claim 1 wherein the sensed finger data set comprises a sensed finger ridge flow data set; and wherein each enrolled finger data set comprises an enrolled finger ridge flow data set; and wherein generating the co-occurrence matrix score comprises reducing a number of matrix entries based upon ridge flow directions.

9. The finger sensing device according to claim 8 wherein reducing the number of matrix entries comprises reducing the number of matrix entries based upon ridge flow directions at a plurality of anchor points.

10. The finger sensing device according to claim 9 wherein said processor cooperates with said finger sensing area to generate the enrolled finger data sets; and wherein the enrolled finger data sets comprise data relating to the plurality of anchor points.

11. The finger sensing device according to claim 1 wherein said finger sensing area comprises at least one of an electric field finger sensing area, a capacitive finger sensing area, an optical finger sensing area, and a thermal finger sensing area.

12. A finger sensing device comprising:
a finger sensing area; and
a processor cooperating with said finger sensing area for generating a sensed finger ridge flow data set, and reducing a number of possible match combinations between the sensed finger ridge flow data set and each of a plurality of enrolled finger ridge flow data sets, the reducing comprising
generating a plurality of overlap hypotheses for each possible match combination,
applying at least one filter to the plurality of overlap hypotheses,
generating a co-occurrence matrix score based upon the plurality of overlap hypotheses for each possible match combination after applying the at least one filter thereto, and
comparing the co-occurrence matrix scores to thereby reduce the number of possible match combinations;
said processor also performing a match operation for the sensed finger ridge flow data set based upon the reduced number of possible match combinations.

13. The finger sensing device according to claim 12 wherein the at least one filter comprises at least one of an overlap area filter, an overlap content filter, and a histogram based distance filter.

14. The finger sensing device according to claim 12 wherein generating the co-occurrence matrix score comprises reducing a number of matrix entries based upon ridge flow directions.

15. The finger sensing device according to claim 14 wherein reducing the number of matrix entries comprises reducing the number of matrix entries based upon ridge flow directions at a plurality of anchor points.

16. The finger sensing device according to claim 15 wherein said processor cooperates with said finger sensing area to generate the enrolled finger ridge flow data sets; and wherein the enrolled finger ridge flow data sets also comprise data relating to the plurality of anchor points.

17. An electronic device comprising:
a housing;
a display carried by said housing;
a finger sensing area carried by said housing; and
a processor cooperating with said finger sensing area for generating a sensed finger data set, and reducing a number of possible match combinations between the sensed finger data set and each of a plurality of enrolled finger data sets, the reducing comprising
generating a plurality of overlap hypotheses for each possible match combination,
generating a co-occurrence matrix score based upon the plurality of overlap hypotheses for each possible match combination, and
comparing the co-occurrence matrix scores to thereby reduce the number of possible match combinations.

18. The electronic device according to claim 17 wherein said processor also performs a match operation for the sensed finger data set based upon the reduced number of possible match combinations.

19. The electronic device according to claim 17 wherein the sensed finger data set comprises a sensed finger ridge flow data set; and wherein each enrolled finger data set comprises an enrolled finger ridge flow data set.

20. The electronic device according to claim 17 wherein reducing further comprises applying at least one filter to the plurality of overlap hypotheses prior to generating the co-occurrence matrix score.

21. The electronic device according to claim 20 wherein the at least one filter comprises at least one of an overlap area filter, an overlap content filter, and a histogram based distance filter.

22. The electronic device according to claim 17 wherein the sensed finger data set comprises a sensed finger ridge flow data set; and wherein each enrolled finger data set comprises an enrolled finger ridge flow data set; and wherein generating the co-occurrence matrix score comprises reducing a number of matrix entries based upon ridge flow directions.

23. The electronic device according to claim 22 wherein reducing the number of matrix entries comprises reducing the number of matrix entries based upon ridge flow directions at a plurality of anchor points.

24. The electronic device according to claim 23 wherein said processor cooperates with said finger sensing area to generate the enrolled finger data sets; and wherein the enrolled finger data sets comprise data relating to the plurality of anchor points.

25. A method for reducing a number of possible match combinations between a sensed finger data set and each of a plurality of enrolled finger data sets, the method comprising:
generating a plurality of overlap hypotheses for each possible match combination;
generating a co-occurrence matrix score based upon the plurality of overlap hypotheses for each possible match combination; and
comparing the co-occurrence matrix scores to thereby reduce the number of possible match combinations.

26. The method according to claim 25 wherein the sensed finger data set comprises a sensed finger ridge flow data set; and wherein each enrolled finger data set comprises an enrolled finger ridge flow data set.

27. The method according to claim 25 further comprising applying at least one filter to the plurality of overlap hypotheses prior to generating the co-occurrence matrix score.

28. The method according to claim 27 wherein the at least one filter comprises at least one of an overlap area filter, an overlap content filter, and a histogram based distance filter.

29. The method according to claim 25 wherein the sensed finger data set comprises a sensed finger ridge flow data set; and wherein each enrolled finger data set comprises an enrolled finger ridge flow data set; and wherein generating the co-occurrence matrix score comprises reducing a number of matrix entries based upon ridge flow directions.

30. The method according to claim 29 wherein reducing the number of matrix entries comprises reducing the number of matrix entries based upon ridge flow directions at a plurality of anchor points.
